(19) United States
(12) Patent Application Publication
(10) Pub. No.: US 2026/0341135 A1
(43) Pub. Date: Oct. 29, 2026

(54) SECURITY SYSTEM FOR ALERTING THE PRESENCE OF KNOWN AND UNKNOWN PERSONS

(71) Applicant: Control Group Companies, LLC, Bridgewater, NJ (US)

(72) Inventors: Thomas John Meehan, Woodcliff Lake, NJ (US); Brian Mark Diplock, Bernardsville, NJ (US); Artan Vatoci, Whippany, NJ (US)

(73) Assignee: Control Group Companies, LLC, Bridgewater, NJ (US)

(21) Appl. No.: 19/550,933

(22) Filed: Feb. 26, 2026

Related U.S. Application Data
(60) Provisional application No. 63/795,894, filed on Apr. 28, 2025.

(51) Int. Cl. G08B 13/24; G08B 13/184

(52) U.S. Cl. CPC G08B 13/248; G08B 13/184

(57) ABSTRACT

A real-time surveillance system that enables automated detection of known and unknown persons at a location and real-time alerts thereof. The surveillance system is configured to utilize (1) A time-of-flight sensor, preferably a Light Detection and Ranging (LiDAR) sensor, to accurately detect the presence and movement of persons at a monitored location in real-time; (2) An article tag and sensor preferably utilizing Radio Frequency Identification (RFID) to identify whether the detected persons are authorized to be at the monitored location; and (3) Artificial Intelligence (AI) to analyze and interpret the combined LiDAR and RFID data, recognize patterns, flag unauthorized presence, and minimize false positives.

### FIELD

This disclosure relates to the field of surveillance monitoring of facilities. More particularly, the disclosure relates to a real-time non-video surveillance system and methods for operating the system that enables automated detection of known and unknown persons and real-time alerts thereof.

### BACKGROUND

Improvement is desired in facility surveillance devices used to monitor ingress/egress to a facility location and for deterring undesirable activities such as theft, harassment, and vandalism.

Video surveillance is commonly used to monitor ingress/egress of persons to a location in a facility. This can benefit both the employer and the employees. Typical facilities using video surveillance are those with items that can easily be removed, such as inventory or cash, as is common with banks, financial institutions and retail stores.

Video surveillance desires improvement, as it does not lend itself to quick intervention and often requires manual review, and can include poor video quality and blind spots or poor visibility of areas. Video surveillance may also raise privacy concerns among employees or customers.

The present disclosure advantageously provides a surveillance system that overcomes many of the shortcomings of conventional surveillance systems and enables automated detection of known and unknown persons at a location and real-time alerts thereof, allowing for swift intervention if indicated.

Security surveillance systems according to the disclosure also advantageously avoid many privacy concerns about privacy, so as to be suitable for use in environments where video surveillance may not be legally permitted or ethically appropriate, such as employee breakrooms or areas where sensitive materials are handled. This allows retailers to maintain a strong security posture without compromising on data privacy or employee trust.

### SUMMARY

The above and other needs are met by a real-time surveillance system that enables automated and real-time detection of known and unknown persons and real-time alerts thereof.

In one aspect, a surveillance system according to the disclosure includes a time-of-flight sensor at a monitored location and operative to detect spatial data including presence and movement of one or more persons at the monitored location in real-time. Each of the one or more persons at the monitored location is either in the possession of an article tag or not in possession of an article tag.

An article tag sensor is provided at the monitored location and configured to sense the presence or absence of one or more of the article tags at the monitored location and provide input data identifying whether the presence of one or more of the article tags has been sensed or not.

A controller is operatively associated with the time-of-flight sensor and the article tag sensor, and is operable to detect the spatial data from the time-of-flight sensor and the input data from the article tag sensor. The controller in response to the spatial data from the time-of-flight sensor and the input data from the article tag sensor is operable to determine the presence of the one or more persons at the monitored location and to determine if the one or more persons are known persons or an unknown persons.

The controller is also operable to generate a real-time output alert based on pre-selected criteria selected for the monitored location by processing spatial data from the time-of-flight sensor and identifying information from the article sensor to determine whether the one or more persons detected at the monitored location are authorized to be at the monitored location.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 shows operation of a surveillance system according to the disclosure when a known person enters a location monitored by the surveillance system.

FIG. 2 shows operation of the surveillance system when an unknown person enters the location monitored by the surveillance system.

FIG. 3 shows operation of the surveillance system when both a known person and an unknown person enter the location monitored by the surveillance system.

FIG. 4 is another view showing operation of the surveillance system when both a known person and an unknown person enter the location monitored by the surveillance system.

### DETAILED DESCRIPTION

With reference to the drawings, the disclosure provides a real-time non-video surveillance system 10 that enables automated detection of known and unknown persons at a location and real-time alerts thereof.

The surveillance system is configured to utilize (1) A time-of-flight sensor, preferably a Light Detection and Ranging (LiDAR) sensor, to accurately detect the presence and movement of one or more persons at a monitored location in real-time by measuring the distance between the sensor and a person, based on the time difference between the emission of a signal and its return to the sensor, after being reflected by the person; (2) An article tag and sensor preferably utilizing Radio Frequency Identification (RFID) to identify whether the detected persons are authorized to be at the monitored location; and (3) Artificial Intelligence (AI) to analyze and interpret the combined LiDAR and RFID data, recognize patterns, flag unauthorized presence, and minimize false positives.

The surveillance system 10 is advantageously configured to be able to trigger accurate alerts that enable rapid response by security personnel and to preserve privacy by avoiding video capture, making it deployable in areas where conventional video surveillance would not be appropriate.

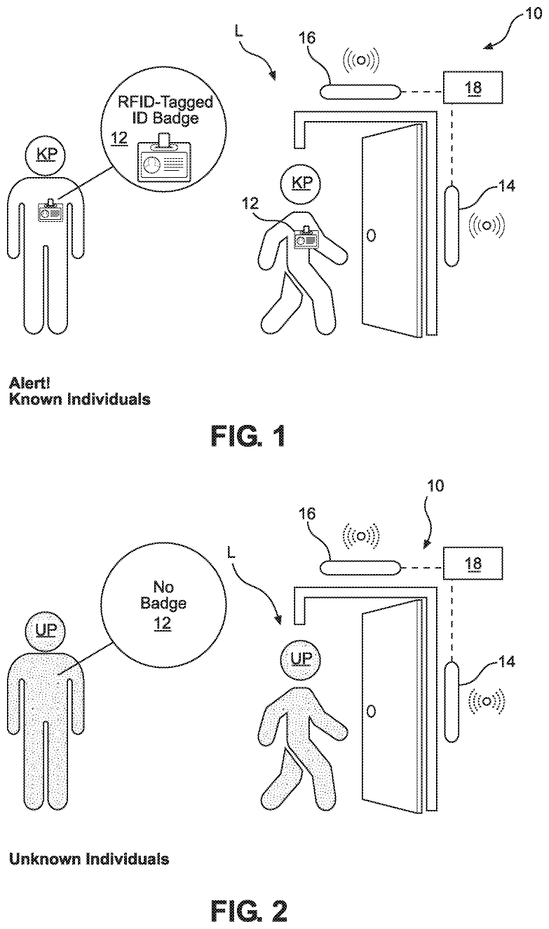

FIG. 1 shows an example of the surveillance system 10 according to the disclosure when a known person KP wearing an identification article 12 is encountered at a location L to be monitored. The location L includes an article sensor 14 and a time-of-flight sensor 16. The article sensor 14 and the time-of-flight sensor 16 are in electrical communication (wired or wireless) with a controller 18.

The known person KP in the example is known because they are wearing the identification article 12. This may, for example, be an authorized employee or vendor of a facility having the identification article 12.

The location L may be any designated area or location that is able to be monitored by the article sensor 14 and the time-of-flight sensor 16. As shown herein, the location L is a doorway into an area, such as entering or exiting a room or a facility. The surveilled areas of each of the article sensor 14 and the time-of-flight sensor 16 encompass at least a portion of the designated location L. However, their surveilled areas may completely overlap, partially overlap, or not overlap at all. For example, as shown, the article sensor 14 is configured to locate the identification article 12 when it is within the doorway. The time-of-flight sensor 16 is located above a location just before the doorway such that it detects the presence and movement of persons as they enter the doorway.

The identification article 12 may be a conventional employee tag or label or vendor pass or other article that the employee or vendor or the like can wear or otherwise possess that can be electronically sensed by the article sensor 14, preferably using RFID technology. For example, the identification article 12 may be an RFID tag or label or sticker of the like having an RFID chip and the article sensor 14 may be an RFID sensor or reader or the like. The identification article 12 is configured to be recognizable by the article sensor 14 as a known article and may also include information such as the name of the employee or the like.

The time-of-flight sensor 16 is configured to be able to track speed, distance and directionality of people passing through the surveilled area of the location L. For example, the time-of-flight sensor 16 may be configured to track any one or combination of a person's speed, direction or change of direction as the person moves through the surveilled area. This allows the system to distinguish people who are shoplifting threats (e.g., a person running near an exit, a person near an exit running towards the exit, a person near an exit abruptly turning in a direction towards the exit, etc.) from people who are not threats (e.g., a person crossing in front of an exit, a person standing near an exit, etc.).

The time-of-flight sensor 16 is desirably a light beam-based sensor such as LiDAR. The light-beam sensor has a relatively fast response time, meaning that a person's speed, direction, change of direction, or any combination of the above, can be quickly derived from the time-of-flight information, and a determination of whether the person's movement amounts to a potential theft or shoplifting event can be made in relatively little time.

The surveillance system 10 includes one or more of the controllers 18 configured for collecting and analyzing sensed data from the article sensor 14 and the time-of-flight sensor 16. For example, as shown, the controller 18 received data from the article sensor 14 indicating that the person detected by the time-of-flight sensor 16 is a known person and generates signals corresponding to this condition. The controller 18 may be programmed to take numerous documentation and notification activities, such as documenting when the person was in the location, how long they are in the location and documentation of any of the other information collectable by the sensors 14 and 16.

The controller 18 may further utilize artificial intelligence (AI) to reference a database or the like to determine whether or not the known person detected is actually authorized to be at that location, or if their activity is commensurate with their activities expected at the location L, such as identifying if the person is moving rapidly or moving back and forth to and from the location L, such as might occur if the person is making multiple trips to remove items from the location L. If not, then an alert could be generated to alert security personnel to rapidly deploy to investigate.

The AI capabilities of the controller 18 include learning from patterns and refining detection criteria over time. For example, if employees consistently enter a stockroom during specific hours or via certain paths, the system 10 can recognize this as normal behavior. If movement patterns deviate, such as someone entering during off-hours or bypassing expected RFID checkpoints, the system 10 can elevate the threat level accordingly. This intelligent monitoring capability minimizes false positives and ensures attention is directed where it matters most.

Thus, the system 10 will be appreciated to leverage artificial intelligence by integrating both LiDAR and RFID to achieve a smarter, privacy-conscious detection and loss prevention system. The AI component acts as the intelligent core, processing spatial data from the LiDAR input data from the time-of-flight sensor 16 and identifying information from RFID from the article sensor 12 to determine whether persons within specific locations, such as areas of a store, are authorized to be there. This creates a dynamic and proactive layer of product protection that helps retailers identify and mitigate threats in real-time.

The use of LiDAR enables the system 10 to generate a detailed, three-dimensional real-time map of the environment, including any people moving within it, such as depicted in FIG. 4. In the retail setting, LiDAR is desirably positioned to monitor sensitive zones such as stockrooms, back-of-house areas, and high-value merchandise zones. Unlike video surveillance, LiDAR does not capture identifying facial features or record video footage. Instead, it tracks spatial data in the form of movement and spatial presence using point-cloud data, which preserves the privacy of persons while still delivering precise detection capabilities.

This spatial data is then combined with real-time RFID input. The system 10 may be configured to continuously analyze both the RFID data from the identification article 12 and the LiDAR data from the time-of-flight sensor 16. When a person is detected in the location L, such as a sensitive area of a facility and no corresponding identification article 12, such as an RFID tag is found, the controller 18 flags the person as an unauthorized or unknown person UP such as shown in FIG. 2. This triggers an alert in real-time, allowing store personnel or the security team to assess and respond quickly.

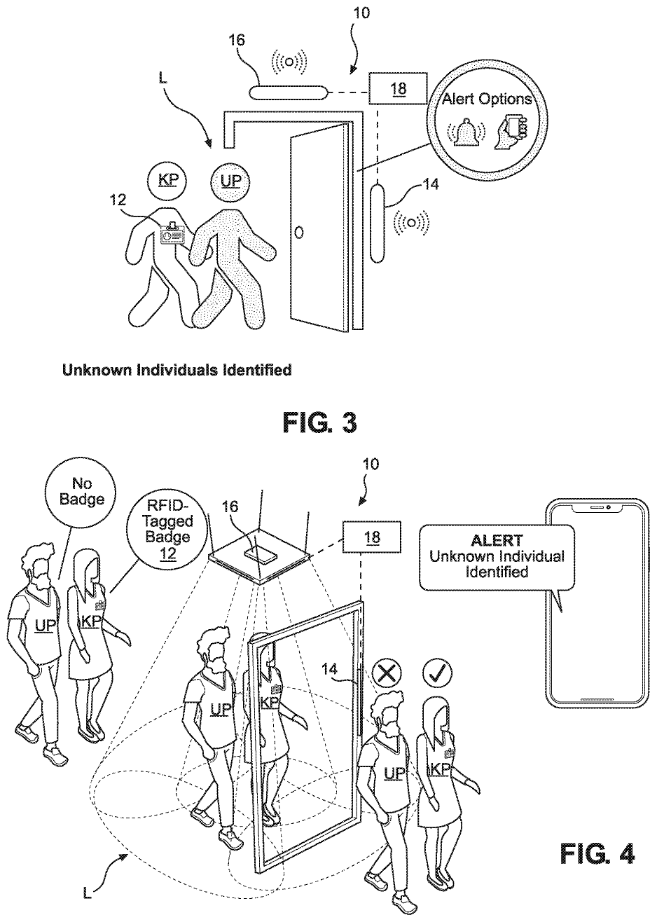

FIGS. 3 and 4 depict circumstances where both a known person KP and an unknown person UP are detected at the location L. FIG. 4 illustrates an example of a detailed, three-dimensional map of the environment, including any people moving within it, but without identifying facial features or the like to preserve privacy. The controller 18 may be programmed to provide desired alerts when this circumstance occur, including documentation, alerting security personnel, or advising security personnel that the known person KP has scheduled to tour the location L with a specified person who will not be wearing an identification article 12, which would explain the unknown person UP, or other criteria as the controller 18 may be initially programmed or later adapt based on AI learning.

The integration of AI in the system 10 with the information from the article sensor 14 and the time-of-flight sensor 16 enables this system 10 to move beyond static rules or threshold-based detection and close a critical gap in traditional security systems. Conventional video surveillance alone may not offer the granularity or real-time responsiveness needed to prevent unauthorized access in sensitive zones, especially in back-of-house areas where visibility is limited. Moreover, video systems often require manual review and may raise privacy concerns among employees or customers. In contrast, this solution enables automated detection and real-time alerts, allowing for swift intervention.

Additionally, the privacy-preserving nature of the system 10, by not utilizing video, makes it suitable for use in environments where video surveillance may not be legally permitted or ethically appropriate, such as employee breakrooms or areas where sensitive materials are handled. This allows retailers to maintain a strong security posture without compromising on data privacy or employee trust.

In summary, the surveillance system of the disclosure delivers a robust and privacy-forward approach to product protection by: (1) leveraging RFID to identify whether those persons are authorized to be in sensitive areas; (2) applying AI to analyze and interpret this combined data, recognize patterns, flag unauthorized presence, and minimize false positives; triggering alerts that enable timely interventions before losses occur; and (3) preserving privacy by avoiding video capture, making the system deployable in areas where surveillance would not be appropriate.

Accordingly, the present device advantageously provides a real-time surveillance system that enables automated detection of known and unknown persons and real-time alerts thereof.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A real-time surveillance system that enables automated detection of known and unknown persons at a location and real-time alerts thereof, the real-time surveillance system comprising:
a time-of-flight sensor at a monitored location and operative to detect spatial data comprising presence and movement of one or more persons at the monitored location in real-time, each of the one or more persons at the monitored location either being in the possession of an article tag or not being in possession of an article tag;
an article tag sensor at the monitored location and configured to sense the presence or absence of one or more of the article tags at the monitored location and provide input data identifying whether the presence of one or more of the article tags has been sensed or not; and
a controller operatively associated with the time-of-flight sensor and the article tag sensor, the controller operable to detect the spatial data from the time-of-flight sensor and the input data from the article tag sensor, the controller in response to the spatial data from the time-of-flight sensor and the input data from the article tag sensor operable to determine the presence of the one or more persons at the monitored location and determine if the one or more persons are known persons or an unknown persons, the controller also operable to generate a real-time output alert based on pre-selected criteria selected for the monitored location by processing spatial data from the time-of-flight sensor and identifying information from the article sensor to determine whether the one or more persons detected at the monitored location are authorized to be at the monitored location.

2. The system of claim 1, wherein the time-of-flight sensor is a Light Detection and Ranging (LiDAR) time-of-flight sensor.

3. The system of claim 1, wherein the article sensor is a Radio Frequency Identification (RFID) sensor.

4. The system of claim 1, wherein the pre-selected criteria selected for the monitored location comprises one or more of time of day, frequency of presence of the one or more persons at the monitored location, and path of entry to the monitored location.
